(19) United States
(12) Patent Application Publication
(10) Pub. No.: US 2025/0095413 A1
(43) Pub. Date: Mar. 20, 2025

(54) Parallel Scalable Data Collection

(71) Applicant: Textron Aviation Inc., Wichita, KS (US)

(72) Inventors: Adam Blake Wolfe, Bentley, KS (US); Haines Todd, Derby, KS (US); Mark Christopher Hansen, Wichita, KS (US)

(21) Appl. No.: 18/783,378

(22) Filed: Jul. 24, 2024

Related U.S. Application Data
(60) Provisional application No. 63/583,900, filed on Sep. 20, 2023.

(51) Int. Cl. G07C 5/00; G06F 13/42

(52) U.S. Cl. CPC G07C 5/008; G06F 13/4247

(57) ABSTRACT

Techniques are disclosed for data collection in connection with one or more aircraft. Avionics inputs are received, at an avionics data collection platform, regarding a plurality of avionics parameters. The avionics parameters may be associated with components of the aircraft and collected by way of avionics sensors. The avionics parameters are aggregated by way of the data collection platform. The aggregated avionics parameters are multiplexed at the data collection platform. The multiplexed and aggregated plurality of avionics parameters are transmitted over loosely-coupled networking connections to an aircraft recording system. The aircraft recording system includes a network collector and an embedded microcontroller system. A prioritized aggregation of the avionics parameters is provided by way of the network collector and the embedded microcontroller system to external systems.

### CROSS-REFERENCE TO RELATED APPLICATIONS

This application claims the benefit of U.S. Provisional Patent Application No. 63/583,900, filed Sep. 20, 2023, the entire contents thereof are herein incorporated by reference.

### BACKGROUND

### 1. Field

Embodiments of the invention relate generally to an architecture and platform for parallel scalable data collection, and more specifically to methods and systems for scalable data collection in connection with networking sensors associated with one or more aircraft.

### 2. Related Art

Various methods for collecting data are known. For example, U.S. Pat. No. 9,576,404 to Ziarno et al. (Ziarno '404) describes a data acquisition unit (DAU) and a PC board forming a wireless local area network (LAN) within an aircraft. The printed circuit board of Ziarno '404 contains processing hardware, memory hardware, and communication hardware. U.S. Pat. No. 9,816,897 to Ziarno (Ziarno '897) describes an engine monitoring system used to collect, save, analyze, and transmit engine data on an aircraft. Ziarno '897 uses many of the components and strategies discussed with respect to Ziarno '404. U.S. Pat. No. 9,882,667 to Hartlmueller et al. describes an interface apparatus for exchanging data as well as a system in which various interface apparatuses can be used to network various avionics components. Hartlmueller describes using the interface apparatus to interface with existing avionics components.

U.S. Pat. No. 11,119,473 to Cella et al. describes systems for collecting and processing data. in an Internet-of-Things (IoT) application. The systems include data collection and processing modules in the context of a system for interfacing multiple data boards to a central mother board.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

Scalable methods and systems are provided for data collection in connection with networked sensors associated with one or more aircraft, the method comprising: receiving, at an avionics data collection platform, a plurality of avionics inputs regarding a plurality of avionics parameters associated with the aircraft, wherein the plurality of avionics parameters is associated with a plurality of components of the aircraft and collected in connection with a plurality of avionics sensors, aggregating by way of the data collection platform the plurality of avionics parameters, multiplexing the aggregated plurality of avionics parameters at the data collection platform, transmitting the multiplexed and aggregated plurality of avionics parameters over one or more loosely coupled networking connections to an aircraft recording system, wherein the aircraft recording system comprises one or more network collectors and one or more embedded microcontroller systems, and providing, by way of the one or more network collectors and the one or more embedded microcontroller systems to one or more external systems, a prioritized aggregation of the plurality of avionics parameters associated with the aircraft.

### BRIEF DESCRIPTION OF THE DRAWING FIGURES

Embodiments of the invention are described in detail below with reference to the attached drawing figures, wherein:

FIG. 1A depicts a block diagram for providing a prior art avionics diagnostics network;

FIG. 1B depicts a block diagram illustrating an avionics diagnostics network, in an embodiment;

FIG. 2 depicts an architectural block diagram illustrating a microcontroller-based embodiment of a data collection interface;

FIG. 3 depicts another architectural block diagram illustrating an example of mechanisms for collecting avionics data in a scalable manner; and

FIG. 4 depicts a flow diagram illustrating an example of mechanisms for collecting avionics data in a scalable manner.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

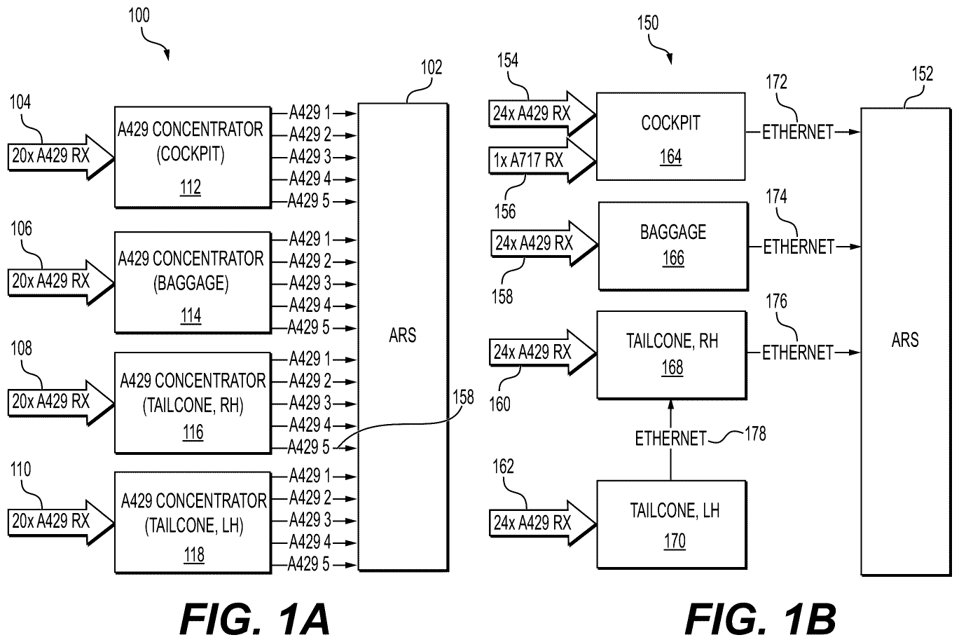

FIG. 1A depicts a block diagram for providing a prior art avionics diagnostics network 100. FIG. 1B depicts a block diagram illustrating an avionics diagnostics network 150, in an embodiment. Aircraft recording system (ARS) units 102 and 152 consistent with the present teachings relate to data acquisition and recording systems designed to be installed in aircraft such as commercial and/or general aviation aircraft. ARS unit 102 may receive and record data from ARINC 429 data buses for retrieval and analysis, such as post-flight retrieval and analysis, for example via avionics data concentrators 112 through 118. ARS unit 152 may receive and record data from ARINC 429, ARINC 717, (controller area network) CAN, and other data buses (e.g., using proprietary protocols) for data retrieval and analysis, such as post-flight retrieval and analysis, for example via avionics data collectors 164 through 170, described below. Stored data may be retrieved from an ARS 102, 152 via a removable mass storage module; downloaded on-aircraft via a network connection, such as wirelessly through Institute of Electrical and Electronics Engineers (IEEE) 802.11 WiFi; wirelessly through fourth generation, a Long Term Evolution (LTE) or GSM cellular connection; wirelessly through the Iridium satellite constellation, or through a wired transport mechanism such as universal serial bus (USB). Frequently, such an ARS recording unit's design may be integrated within an aircraft so as to be permanently installed in the aircraft.

ARS 102, 152 consistent with the present teachings may be advantageously used by various types of users. Customer service technicians can use the recorded data to troubleshoot notifications from the field regarding aircraft functionality. Flight data can be analyzed or archived during aircraft manufacture or pre-delivery. Manufacturing personnel can use the system to run functional tests, and engineers can use the data in investigating system anomalies. ARS 152 consistent with the present teachings may be capable of receiving and/or transmitting data on multiple types of avionics data buses, such as: ARINC 429, ARINC 717, CAN, and other data buses. ARS 102, 152 consistent with the present teachings may employ one or more data collection interface boards, which may be connected by LAN and which may interact with additional hardware and/or software interfaces which may be located onboard an aircraft. Consistent with the present teachings, more data and more different types may be recorded in a scalable manner and with full native rate sampling and full instrumentation.

As shown in FIG. 1A, prior art avionics diagnostics network 100 receives data via ARINC 429 channels 104, 106, 108, and 110. For example, each of ARINC 429 channels 104, 106, 108, and 110 may include 20 channels. ARINC 429 data concentrators 112, 114, 116, and 118 are configured to compress data onto fewer channels, for example four channels compressed to one, including data multiplexing. The multiplexing method results in data loss. The concentrated data channels (e.g., A429 1-5 shown in FIG. 1A) are output to ARS 102 for recording of data. The ARINC 429 data concentrators 112, 114, 116, and 118 are ARINC 429 protocol data buses, which are proprietary (ARINC is an acronym for Aeronautical Radio, Incorporated) and at the end of their lifetime necessitating an upgraded data bus architecture.

As shown in FIG. 1B, remotely located data collectors 164, 166, 168, 170 are provided with ethernet connectivity pathways 172, 174, 176, 178 to ARS 152, with solid line boxes internal to systems consistent with the present teachings. The ethernet pathways enable data to be multiplexed from the data collectors 164, 166, 168, 170 to ARS 152 without data loss. Data inputs 154, 156, 158, 160, 162 may include but are not limited to ARINC 429, ARINC 717, CAN, and other data buses/protocols, which provides advantages over the prior art avionics diagnostics network 100 which is limited to ARINC429 protocol data buses. A data collection platform is implemented in connection with ARS 152.

In embodiments, data collectors 164, 166, 168, 170 are data buses dispersed in remote locations (i.e. remotely located from the cockpit or another centralized computing station within the aircraft), which provides shorter wire paths from many input sources (e.g., sensors) leading to an overall reduction in wire weight. For example, data collector 164 may be located in the cockpit and configured to receive cockpit data (e.g., autopilot, GPS); data collector 166 may be located in or near the baggage compartment and configured to receive data from within a baggage compartment (e.g., a pressurization controller); data collector 168 may be located in a right-hand tail cone section and configured to receive data from sensors in the right-hand tail cone, and data collector 170 may be located in the left-hand tail cone section and configured to receive data from sensors in the left-hand tail cone. Other aircraft locations may be used for housing these or additional data collectors since one of the key features of avionics diagnostics network 150 is a scalable architecture connectable to an unlimited number of data collectors, providing a built-in capability to increase data input sources. Data received by data collectors 164, 166, 168, 170 may be any avionics parameters such as diagnostics output from other printed circuit boards (PCBs) on the aircraft (e.g., PCBs for a full-authority digital engine controller (FADEC), spoiler monitor, flap monitor, flap control, weight on wheels, dimming control, etc.).

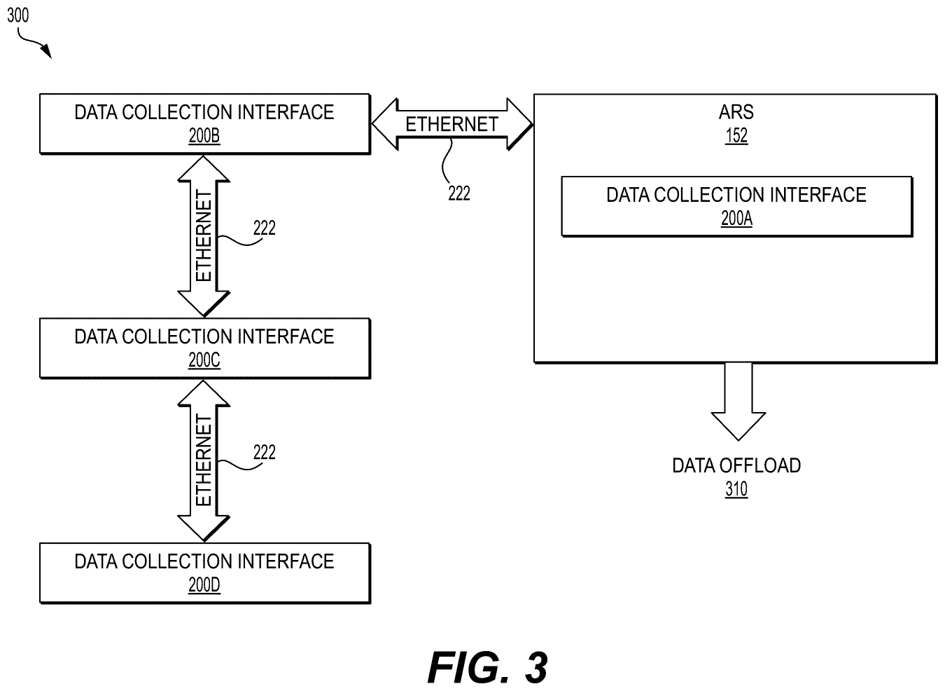

In embodiments, data collectors 164, 166, 168, 170 may be communicatively coupled for data transfer to one another while being indirectly coupled to ARS 152. For example, as depicted in FIG. 1B, data collector 170 in the lefthand tail cone may have ethernet connectivity 178 to data collector 168 in the righthand tail cone only and without data collector 170 having direct ethernet connectivity (or any data communication) with ARS 152. Instead, data collector 170 is communicatively coupled with ARS 152 via ethernet connectivity 178 and 176. In this manner, a plurality of data collectors may be daisy chained together via ethernet connectivity enabling the network of data collectors to be expandable, as further described below in connection with FIG. 3.

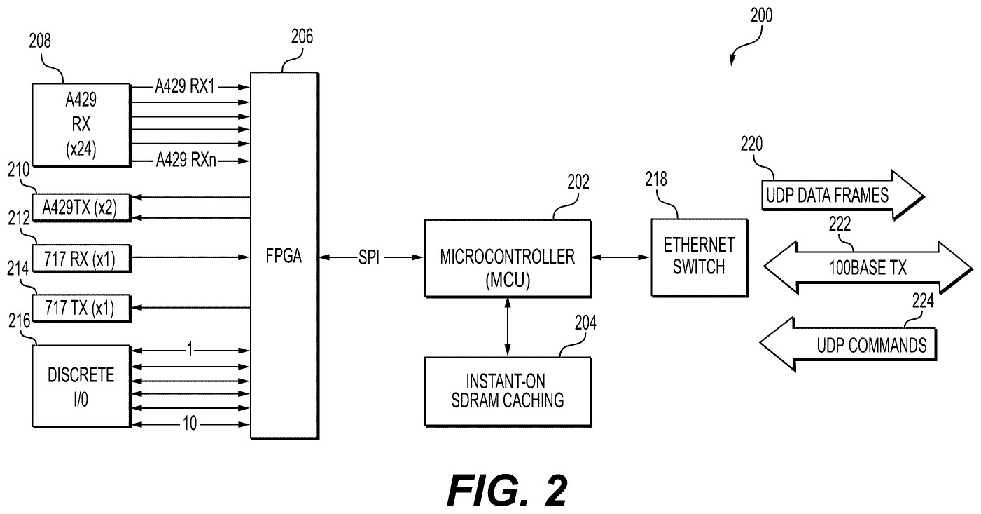

FIG. 2 depicts an architectural block diagram illustrating a microcontroller-based embodiment of a data collection interface 200. Data collection interface 200 is an example of data collectors 164, 166, 168, and 170 of FIG. 1B and may comprise a configurable PCB for example. A field-programmable gate array (FPGA) 206 is communicatively coupled with a microcontroller unit (MCU) 202 via a serial peripheral interface (SPI) 205. FPGA 206 is for example an Intel® MAX 10® FPGA device. MCU 202 is for example an embedded Infineon Technologies 32-bit Arm® Cortex®-M4 Microcontroller. SPI 205 is a serial communication bus, for example Mode 1 SPI with a clock speed of about 16 MHz in which MCU 202 orchestrates communication with FPGA 206 as a subservient peripheral. As depicted in the FIG. 2 embodiment, data inputs/outputs going to/from FPGA 206 may include but are not limited to ARINC 429 data inputs 208, ARINC 429 data outputs 210, ARINC 717 data input 212, ARINC 717 data output 214, and discrete input/outputs 216.

In embodiments, ARS 152 comprises a CPU having a non-real-time operating system that requires a non-trivial amount of time to boot (e.g., fifteen to thirty seconds), which necessitates caching data while ARS 152 is booting. A synchronous dynamic random-access memory (SDRAM) 204 is configured to provide instant-on data caching from MCU 202. SDRAM 204 is for example a 16 MB IS42S16800F-7TLI from Integrated Silicon Solution Inc. When ARS 152 is unavailable (e.g., booting), data is cached to SDRAM 204 and later transferred to ARS 152 when available.

Ethernet switch 218 is communicatively coupled to MCU 202. Ethernet switch 218 is for example a KSZ8895MQI from Microchip Technology. Ethernet switch 218 is configured to manage data flow across the ethernet network (e.g., ethernet pathways 172, 174, 176 shown in FIG. 1B) to provide data communication between MCU 202 and ARS 152.

Data provided to ARS 152 is in the form of output User Datagram Protocol (UDP) data frames 220. Commands provided to MCU 202 comprise input UDP commands 224. These data are transmitted between MCU 202 and ARS 152 over ethernet, such as 100Base-TX 222 for example, which is a 100 Mbit/s baseband signaling fast ethernet connection. Alternatively, a 1 Gbps ethernet link may be used.

In embodiments, MCU 202 hosts the controllers to interact with FPGA 206, SDRAM 204 (e.g., SDRAM Controller), and ethernet switch 218 (e.g., Ethernet MAC Controller).

FIG. 3 shows a block diagram of a scalable data collection architecture 300. Data stored in ARS 152 may be offloaded via a data offload pathway 310, which includes but is not limited to a removable mass storage module, a wired or wireless network connection such as a LAN, 802.11 WiFi, LTE or GSM cellular connection, the Iridium satellite constellation, or through a wired transport mechanism such as universal serial bus (USB) for example.

As shown in FIG. 3, ARS 152 includes its own data collection interface 200A. Additionally, an externally located data collection interface 200B may be communicatively coupled to ARS 152 via ethernet connectivity 222 (e.g., 100BASE-TX described above in connection with FIG. 2). Since each data collection interface 200 has two ethernet ports, an ethernet cable may be used to communicatively couple or loosely couple (i.e., daisy chain) to an additional data collection interface 200 associated with the data collection platform implemented within ARS 152. As shown in FIG. 3, data collection interface 200C is daisy chained to data collection interface 200B via ethernet connectivity 222, and data collection interface 200D is daisy chained to data collection interface 200C. Additional data collection interfaces 200 may be added in this manner an unlimited number of times. Therefore, scalable data collection architecture 300 enables facile expansion of the data collection network while maintaining full native rate sampling and full instrumentation and without multiplexing data.

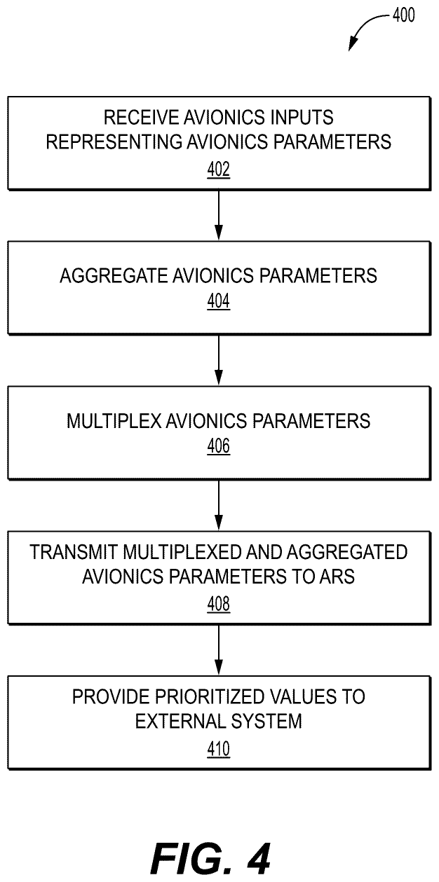

FIG. 4 depicts a flow diagram illustrating an exemplary scalable avionics data collection method 400. In step 402, avionics inputs are received. The avionics inputs represent avionics parameters from an aircraft avionics bus, for example. In step 404, avionics parameters may be aggregated on a prioritized basis, for example on the basis of criticality of sensor reading such as safety-relevant avionics parameters. For example, as described above in connection with FIG. 2, data collection interface 200 aggregates avionics parameters. In step 406, avionics data is multiplexed for transmission via ethernet without data loss. In step 408, avionics data is transmitted to ARS 152 for recording. In step 410, recorded data is transmitted to an external system. For example, recorded data is wirelessly transmitted from ARS 152 to an external server via one or more wireless network interfaces.

In some embodiments, aircraft flight data monitoring (FDM) systems and services may be provided for aircraft by way of one or more ARS 152. In some embodiments ARS 152 may be provided in the context of a data reporting ecosystem. Users of ARS 152 may elect to transfer flight data to one of various user-selected flight operational quality assurance (FOQA) providers, which may include (Flight Data Services L3Harris Technologies' Flight Data Connect service or Safran Electronics & Defense's Cassiopée Flight Data Monitoring solution). ARS 152 users may receive support via ARS vendors, through a global network of service and part centers, mobile service units and 24/7 support.

Such FDM programs facilitate the ability for users to improve operational efficiency, training, and reliability by transferring flight data to customer-selected data management providers, allowing users to select a service provider that best fits their needs, ensuring they receive the most comprehensive flight data monitoring capabilities for their aircraft. Wireless transfer of data to the provider of choice requires no additional equipment, making it a simple and seamless process. Systems consistent with the present teachings provide fault notification and diagnostics enable downtime reduction, returning the aircraft to service faster than ever.

In some embodiments, significant benefits may be realized by employing the following aspects of the present teachings. First, connectivity may be provided such as cellular where possible WiFi, and satellite-based networks for backup. Scalable architecture may be provided, including unlimited number of data buses (data collection interface concept), scalable ethernet connected backbone, not bandwidth limited ARS interfaces to any system with data that can be collected. This includes multiple avionics boxes (e.g., autopilot, GPS), 3rd party LRUs (e.g., boxes) that are integrated (e.g., pressurization controller). Customers may benefit from internally developed electronic systems to provide diagnostics data used from benchtop all the way to delivery of plane to customer data automatically offloaded.

Consistent with the present teachings, new capabilities may be provided facilitating further scalability. For example, ethernet ports can be used to connect more data collection interface boards 200 (which each have two ethernet ports so data collection interface boards can be daisy chained together). ARS 152 consistent with the present teachings facilitate arbitrary and potentially subsequently developed technology to be connected as set forth in connection with the present teachings.

ARS units consistent with the present teachings provide data acquisition and recording mechanisms designed to be installed in one or more aircraft. ARS units consistent with the present teachings may receive and record data from numerous ARINC 429 aircraft data buses for post-flight retrieval and analysis. Stored data may be retrieved from the unit via a removable mass storage module, downloaded on-aircraft via an Ethernet connection, wirelessly through 802.11 WiFi, or through USB. The recording unit is intended to be permanently installed in the aircraft.

Data collection interface 200A is for example a PCB assembly that serves as a companion board to ARS 152 consistent with the present teachings that may serve as its primary data collector. Data collection interface 200A can collect data from Discrete I/O pins, ARINC 429, ARINC 717, and other data buses. Data collection interface 200A interfaces with ARS 152 consistent with the present teachings via Ethernet. Data collection interfaces, data buses and I/O pins, may be configured by ARS over such an interface. Multiple uniquely identifiable data collection interfaces 200A, 200B, 200C, etc. can be connected to ARS 152 with the present teachings at one time.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A scalable method for data collection in connection with networked sensors associated with one or more aircraft, the method comprising:
receiving a plurality of avionics inputs regarding a plurality of avionics parameters associated with the aircraft,
wherein the plurality of avionics parameters is associated with a plurality of components of the aircraft and collected in connection with a plurality of avionics sensors;
aggregating by way of a data collection platform the plurality of avionics parameters;
multiplexing the aggregated plurality of avionics parameters at the data collection platform;
transmitting the multiplexed and aggregated plurality of avionics parameters over one or more loosely coupled networking connections to an aircraft recording system,
wherein the aircraft recording system comprises one or more network collectors and one or more embedded microcontroller systems; and
providing, by way of the one or more network collectors and the one or more embedded microcontroller systems to one or more external systems, a prioritized aggregation of the plurality of avionics parameters associated with the aircraft.

2. The method of claim 1, wherein the plurality of avionics sensors comprises one or more of: a full-authority digital engine controller, a spoiler monitor, a flap monitor, a flap control sensor, a weight on wheels sensor, and a dimming control input.

3. The method of claim 1, wherein the one or more loosely coupled networking connections comprises one or more daisy-chained ethernet connections.

4. The method of claim 1, wherein the aircraft recording system further comprises one or more wireless network devices.

5. The method of claim 4, wherein one or more wireless network devices comprises at least one of: an IEEE 802.11 wireless connection, a cellular connection, and an Iridium satellite constellation connection.

6. The method of claim 1, wherein the avionics data collection platform is permanently installed in the aircraft.

7. The method of claim 1, wherein the prioritized aggregation of the plurality of avionics parameters associated with the aircraft further comprises:
transferring the plurality of avionics parameters to user-selected flight operational quality assurance providers.

8. A system for facilitating scalable data collection in connection with networking sensors and information systems associated with one or more aircraft, the system comprising:
at an avionics data collection platform configured to receive a plurality of avionics inputs regarding a plurality of avionics parameters associated with the aircraft,
wherein the plurality of avionics parameters is associated with a plurality of components of the aircraft and collected in connection with a plurality of avionics sensors;
a network collector configured to aggregate the plurality of avionics parameters in connection with the data collection platform;
a plurality of ethernet pathways for multiplexing the aggregated plurality of avionics parameters at the data collection platform,
wherein the plurality of ethernet pathways are configured to transmit the multiplexed and aggregated plurality of avionics parameters over one or more loosely coupled networking connections to an aircraft recording system,
wherein the aircraft recording system comprises one or more network collectors and one or more embedded microcontroller systems; and
a sensor aggregator configured to provide, by way of the one or more network collectors and the one or more embedded microcontroller systems to one or more external systems, a prioritized aggregation of the plurality of avionics parameters associated with the aircraft.

9. The system of claim 8, wherein the plurality of avionics sensors is physically located in one or more physical locations within the aircraft, the physical locations comprising: a cockpit, a baggage compartment, and one or more tail cones.

10. The system of claim 8, wherein the one or more loosely coupled networking connections comprises one or more daisy-chained ethernet connections.

11. The system of claim 8, wherein the aircraft recording system further comprises one or more wireless network devices.

12. The system of claim 11, wherein one or more wireless network devices comprises at least one of: an IEEE 802.11 wireless connection, a cellular connection, and an Iridium satellite constellation connection.

13. The system of claim 8, wherein the avionics data collection platform is permanently installed in the aircraft.

14. The system of claim 8, wherein the prioritized aggregation of the plurality of avionics parameters associated with the aircraft further comprises:
transferring the plurality of avionics parameters to user-selected flight operational quality assurance providers.

15. One or more non-transitory computer-readable media storing computer-executable instructions that, when executed by a processor perform a method for facilitating scalable data collection in connection with networking sensors and information systems associated with one or more aircraft, the method comprising:
receiving, at an avionics data collection platform, a plurality of avionics inputs regarding a plurality of avionics parameters associated with an aircraft,
wherein the plurality of avionics parameters is associated with a plurality of components of the aircraft and collected in connection with a plurality of avionics sensors;
aggregating by way of the data collection platform the plurality of avionics parameters;
multiplexing the aggregated plurality of avionics parameters at the data collection platform;
transmitting the multiplexed and aggregated plurality of avionics parameters over one or more loosely coupled networking connections to an aircraft recording system,
wherein the aircraft recording system comprises one or more network collectors and one or more embedded microcontroller systems; and
providing, by way of the one or more network collectors and the one or more embedded microcontroller systems to one or more external systems, a prioritized aggregation of the plurality of avionics parameters associated with the aircraft.

16. The computer-readable media of claim 15, wherein the plurality of avionics sensors comprises one or more of: a full-authority digital engine controller, a spoiler monitor, a flap monitor, a flap control sensor, a weight on wheels sensor, and a dimming control input.

17. The computer-readable media of claim 15, wherein the one or more loosely coupled networking connections comprises one or more daisy-chained ethernet connections.

18. The computer-readable media of claim 15, wherein the aircraft recording system further comprises one or more wireless network devices.

19. The computer-readable media of claim 18, wherein one or more wireless network devices comprises at least one of: an IEEE 802.11 wireless connection, a cellular connection, and an Iridium satellite constellation connection.

20. The computer-readable media of claim 15, wherein the prioritized aggregation of the plurality of avionics parameters associated with the aircraft further comprises:
transferring the plurality of avionics parameters to user-selected flight operational quality assurance providers.
